(19) United States
(12) Patent Application Publication
(10) Pub. No.: US 2018/0334591 A1
(43) Pub. Date: Nov. 22, 2018

(54) SYSTEM AND CORRESPONDING METHOD FOR HOT APPLICATION OF AN ADHESIVE COMPOSITION

(71) Applicant: BOSTIK SA, LA PLAINE SAINT DENIS (FR)

(72) Inventor: Jean Francois CHARTREL, Cuts (FR)

(73) Assignee: BOSTIK SA, LA PLAINE SAINT DENIS (FR)

(21) Appl. No.: 16/049,440

(22) Filed: Jul. 30, 2018

Related U.S. Application Data
(62) Division of application No. 14/552,646, filed on Nov. 25, 2014.

(30) Foreign Application Priority Data
Nov. 29, 2013 (FR) 13/61818

(51) Int. Cl. C09J 5/06; B29B 13/02; B05D 1/02; B05C 11/10; B05B 1/24; B01F 3/22; B01F 5/06; B05B 7/16; B01F 15/06; B05B 15/20; B05C 5/02

(52) U.S. Cl. CPC C09J 5/06; B29B 13/022; B05D 1/02; B05C 11/1042; B05B 1/24; B01F 3/2284; B05C 5/0254; B05B 7/16; B01F 15/068; B01F 15/065; B05B 15/20; B01F 2015/062; B01F 5/0619

(57) ABSTRACT

A system for hot application of an adhesive composition, comprising an in-line heating device and a corresponding method for hot application of the adhesive composition. The system comprises:
an application nozzle for applying the adhesive composition;
a supply line for supplying the nozzle with the adhesive composition to be applied in fluid form;
a in-line heating device for heating of the adhesive composition to an application temperature, the heating device comprising:
   a static mixture including an electrically conducting material, and
   an inductive cable surrounding the static mixer.

The invention relates to a system for hot application of an adhesive composition comprising an in-line heating device and to a corresponding method for hot application of the adhesive composition.

In the adhesive industry, adhesive surfaces may be produced by the technique of hot application of the adhesive composition on a surface. FIG. 1 shows a system 100 according to the prior art for hot application of an adhesive composition 80. This system 100 comprises a reservoir 82 for storing the adhesive composition 80, here in the form of a barrel of 200 litres. The adhesive composition 80 is intended to be applied on a surface 96, here a polyester film running on a cylinder 92 with an axis 94. This application is achieved by means of a gluing nozzle 90 for forming an adhesive surface 98. Supplying the nozzle with adhesive composition to be applied 80 is achieved by means of a fluidic communication line 88 of the adhesive composition between the barrel and the nozzle 90, the line 88 being provided with a pump 86 for circulating the adhesive composition.

In order to facilitate application by the nozzle 90 and pumping from the barrel to the nozzle 90, the adhesive composition 80, which may be solid at room temperature, is for example heated to a temperature from 100° C. to 180° C. in order to have sufficient viscosity. The system 100 then comprises a heater 84 upstream from the pump 86. The heater 84 corresponds for example to a melting tray put into contact with the adhesive composition in the barrel. This melting tray is electrically heated by heating resistors. The amount of heat transferred from the heater 84 to the adhesive composition 80 notably depends on the exchange surface area between the heater 84 and the adhesive composition 80. With reference to FIGS. 2, 3 and 4, different alternatives of the melting tray may then be contemplated, respectively an alternative 70 with a smooth exchange surface 76 and alternatives 72 and 74 with exchange surfaces having fins 78.

This system 100 however does not have satisfactory operation in the cases when the adhesive composition 80 to be applied comprises a reactive pre-polymer and has an application temperature from 100 to 120° C. for example, too close to a crosslinking temperature range, from 100° C. to 140° C. for example. Indeed, such an adhesive composition 80 heated in the storage reservoir 82 with a targeted heating temperature greater than or equal to 100° C. begins to crosslink, and a fortiori in the presence of humidity. Indeed with such a heater 84 in the storage reservoir 82, the residence time of the adhesive composition 80 at 100° C. is poorly controlled on the one hand and the actually applied temperature is also poorly controlled on the other hand. Therefore, there exists a risk of complete crosslinking of the adhesive composition 80 in contact with the fins 78 of the heater 84, resulting in the formation of a crosslinked compact block. Such a crosslinked block may obturate the melting tray 72 or 74 and prevent any circulation of fluid adhesive composition 80 to the application nozzle 90. This risk of fouling of the melting tray 72 or 74 is particularly worsened for adhesive compositions which cross link with humidity. Indeed, each barrel change exposes the residues of adhesive compositions on the tray to the humidity of the air then reinforcing the crosslinking of these residues on the tray.

Therefore there exists a need for applying a reactive adhesive composition having an application temperature close to a crosslinking temperature.

More particularly, the invention is directed to providing a system and a method for applying such an adhesive composition.

For this purpose, the present invention proposes a system for hot application of an adhesive composition on a support, the system comprising:
an application nozzle for applying the adhesive composition;
a supply line for supplying the nozzle with the adhesive composition to be applied in a fluid form;
an in-line heating device for heating the adhesive composition to an application temperature, the heating device comprising:
a static mixer including an electrically conducting material, and
an inductive cable surrounding the static mixer.

According to preferred embodiments, the invention comprises one or more of the following features:
the system comprises a storage reservoir comprising the adhesive composition to be applied, the storage reservoir being connected to the supply line of the application nozzle.
the adhesive composition to be applied comprises a reactive pre-polymer, crosslinking in a temperature range, the adhesive composition to be applied having an application temperature range included in the crosslinking temperature range.
the adhesive composition to be applied is fluid under standard conditions of temperature and pressure.
the system comprises heater able to be positioned at a storage reservoir comprising the adhesive composition to be applied, for raising the adhesive composition 80 to be applied to a pumping temperature.
the system comprises a pump for circulating the adhesive composition in a supply line, the pump being able to circulate an adhesive composition having a viscosity of 1,000 Pa·s, preferably 600 Pa·s, more preferably 500 Pa·s.
the static mixer of the heating device comprises:
   a sheath forming a portion of the supply line for supplying an adhesive composition, the sheath being made in an electrically insulating material, preferably in glass or in a polymer without any conductive fillers; and
   a mixing element having deflective surfaces for deflecting the adhesive composition circulating in the sheath, the mixing element being made in an electrically conducting material and positioned in the sheath.
the mixing element positioned in the sheath has a density of heat exchange surfaces greater than or equal 5*10³ m⁻¹, preferably comprised between 5*10³ m⁻¹ and 10*10³ m⁻¹.

The invention further relates to a method for hot application of an adhesive composition on a support, the method comprising:
providing the previous application system and a storage reservoir comprising the adhesive composition to be applied and connected to the supply line of the application nozzle;
circulating the adhesive composition from the storage reservoir to the in-line heating device ;
heating the pumped adhesive composition up to the application temperature, by the supply of electric power to the inductive cable of the heating device;
hot application of the adhesive composition on a support by means of the application nozzle.

According to an embodiment of the hot application method, the adhesive composition is applied with a viscosity of 15 Pa·s±5 Pa·s.

According to an embodiment of the hot application method, the adhesive composition is applied at a temperature comprised between 50° C. and 140° C., preferably comprised between 80° C. and 120° C., more preferably between 100° C. and 110° C.

The invention more further relates to a method for producing a crosslinked adhesive support, the method comprising:
providing a support;
applying an adhesive composition onto the support by means of the previous method;
crosslinking the adhesive composition applied at a temperature comprised between 50° C. and 200° C., preferably comprised between 80° C. and 160° C., more preferably between 100° C. and 140° C.

Other features and advantages of the invention will become apparent upon reading the description which follows of embodiments of the invention, given as an example and with reference to the appended drawings.

### BRIEF DESCRIPTION OF THE DRAWINGS

FIG. 1 shows a system for applying an adhesive composition according to the prior art.

FIGS. 2, 3 and 4 show various alternatives of a melting tray used in the system of FIG. 1.

FIG. 5 shows a proposed system for applying an adhesive composition comprising an in-line heating device for the adhesive composition.

FIG. 6 shows a schematic sectional view of the in-line heating device of the system of FIG. 5.

FIG. 7 shows an embodiment of a mixing element of the device of FIG. 6.

A system is proposed for hot application of an adhesive composition, in particular of a crosslinkable adhesive composition and notably of an adhesive composition crosslinkable with heat and humidity. This adhesive composition once it is crosslinked may correspond to a pressure sensitive adhesive composition (abbreviated as PSA).

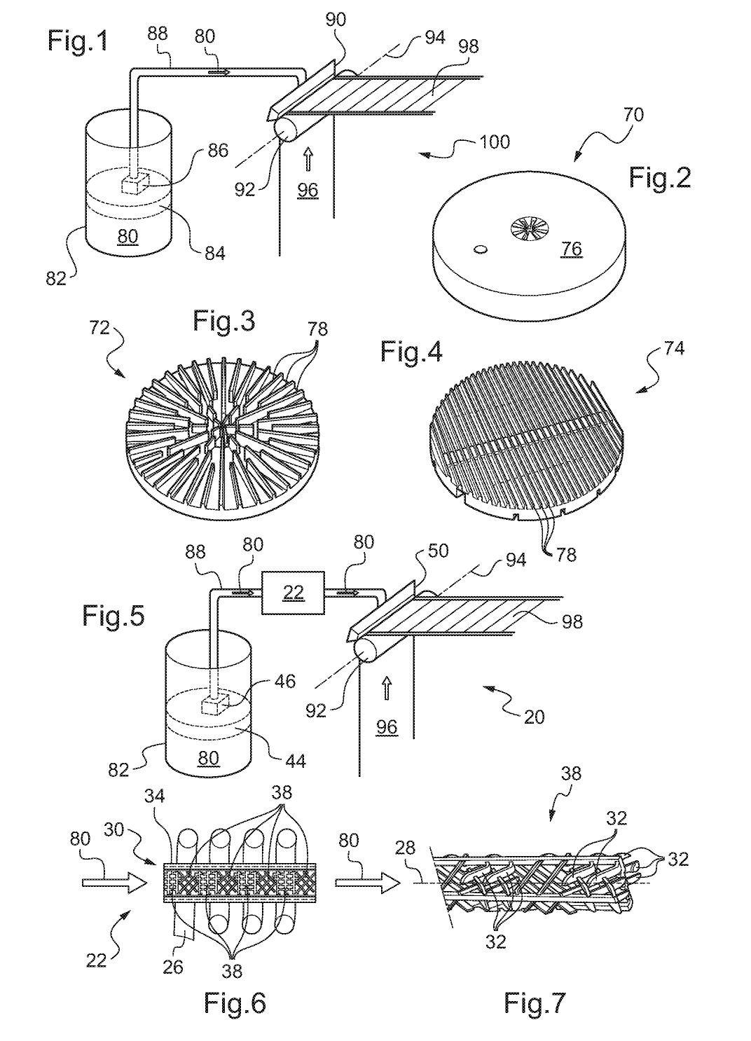

FIG. 5 shows a schematic illustration of an embodiment of the proposed system 20. The elements common to FIGS. 1 and 5 have the same reference signs. The proposed system 20 notably differs from the system 100 of FIG. 1 in that it includes a heating device 22 in line 88.

The heating device 22 contributes to setting an application temperature of the adhesive composition 80. The application temperature corresponds to a temperature where the adhesive composition to be applied has sufficiently low viscosity for allowing the application, in other words the coating, of the adhesive composition 80 on the surface 96. An application temperature of the adhesive composition 80 may thus correspond to a temperature where the viscosity of the adhesive composition is less than or equal to 20 Pa·s, preferably less than or equal to 10 Pa·s. As an example, the adhesive composition 80 may have a viscosity of 15 ±5 Pa·s at an application temperature from 100° C. to 120° C.

As compared with the heater 84 positioned in the storage reservoir 82, here in the form of a barrel, the heating device 22 is distinguished in that it is positioned in line 88. In other words, the heating device 22 achieves heating of the adhesive composition 80 when the adhesive composition 80 is in motion. This heating in motion, further called in-line heating, allows a reduction in the hot residence time of the adhesive composition 80 as compared with heating of the adhesive composition 80 in the storage reservoir 82 where the hot adhesive composition 80 is quasi at a standstill.

By allowing a reduction of the hot residence time of the adhesive composition 80, the in-line heating device 22 may achieve the setting of the application temperature of the adhesive composition 80, even in the case when the application temperature is included in the crosslinking temperature range of the adhesive composition 80. Indeed, depending on the intended application temperature included in the crosslinking temperature range, the hot residence time of the adhesive composition 80 in motion may be adapted. The hot residence time of the adhesive composition in motion may notably be modulated with the flow rate of the adhesive composition 80 and the line capacity 88 between the in-line heating device 22 and the application nozzle 50. For example, for an adhesive composition 80 to be applied at 100° C. and having a crosslinking temperature range from 100° C. to 120° C. with crosslinking times from one to a few minutes (without additionally providing humidity), the flow rate of the in-line adhesive composition 80 may be adjusted so that the crosslinking reaction remains limited so as not to foul the system with crosslinked adhesive composition. The progress of the crosslinking reaction may be appreciated by referring to the conversion rate of the crosslinking reaction in the system, determined according to the following equation:

$$X = \frac{{\dot{m}}_{0} - {\dot{m}}_{t}}{{\dot{m}}_{0}} \qquad ( 1 )$$

wherein X is the dimensionless conversion rate;
\dot{m}₀ is the mass flow rate of non-crosslinked adhesive composition at the barrel-shaped storage reservoir 82;
\dot{m}ₜ is the mass flow rate of the non-crosslinked adhesive composition at the nozzle 50.

The flow rate of the in-line adhesive composition 80 may thus be adjusted so that, according to the reaction kinetics and according to the temperature, in particular in the static mixer, the conversion rate of the reaction for crosslinking the adhesive composition remains less than or equal to 30%, preferably less than or equal to 10%. The flow rate of the adhesive composition 80 in the in-line heating device is for example comprised between 80 g·s⁻¹ and 170 g·s⁻¹, i.e. about 5 to 10 kg per minute, such as equal to 120 g·s⁻¹, i.e. about 7 kg per minute.

In order to allow setting of the application temperature of the adhesive composition 80 at a high rate, the in-line heating device 22 has a structure adapted to very efficient heating. FIG. 6 shows a longitudinal sectional view of an embodiment of the in-line heating device 22. In order to allow fast setting of temperature, the in-line heating device 22 includes heating by induction. Thus, the in-line heating device 22 comprises an inductive cable 26, here in the form of a solenoid, in order to allow generation of a magnetic field.

The in-line heating device 22 further comprises a static mixer 30 in which the adhesive composition to be heated 80 may circulate. Static mixers are notably known for their use in the industry of injection molding in order to homogenize the material before injection into a mold. Static mixers known from the prior art comprise mixing elements having surfaces for deflecting the fluid, directed to obtaining a homogeneous mixture of the fluid over a short distance and with low shearing.

Similarly to known static mixers, the static mixer 30 included in the in-line heating device 22 comprises at least such a mixing element 38. As illustrated, the static mixer has an assembly of mixing elements 38 positioned in a sheath 34. The sheath 34 forms a conduit for circulating the adhesive composition 80. The sheath 34 and said at least one mixing element 38 forms the static mixer 30 of the in-line heating device 22. When the in-line heating device 22 is integrated to the system 20 of FIG. 5, the sheath 34 as a circulation conduit, is a portion of the line 88.

The static exchanger 30 formed here by the proposed heating device 22, however has the particularity of including an electrically conducting material. In this document, by an electrically conducting material is meant a material having a resistivity of less than 10 Ω·m, preferably less than 10⁻⁶ Ω·m. The magnetic field generated by the inductive cable 26 surrounding the static mixer 30 is then able to induce an electric current, known as an eddy current or Foucault current, in the electric conductor of the static mixer 30. The eddy currents induced in the electric conductor cause heat generation by the Joule effect, which diffuses into the adhesive composition 80 via components of the static mixer 30.

The efficiency of the thermal exchange of the heat generated between the static mixer 30 and the adhesive composition 80 depends on the structure of the sheath and, in particular, on the mixing element 38 and their useful heat exchange surface area. FIG. 7 shows an embodiment of one of the mixing elements 38 of the in-line heating device 22. The mixing element 38 has deflective surfaces 32 which form various angles relatively to the main direction 28 of the circulation of the adhesive composition 80 in the static mixer 30. This mixing element 38 having these deflective surfaces then has a high surface area density in contact with the adhesive composition 80 to be mixed. The surface density corresponds to an amount of exchange surface areas per volume and is therefore expressed in m²/m³, i.e. in m⁻¹. The mixing elements 38 comprised in the in-line heating device 22 may have a surface density greater than or equal to 5*10³ m⁻¹, preferably comprised between 5*10³ m⁻¹ and 10*10³ m⁻¹. Such surface densities for example correspond to a static mixer with a length from 40 to 60 cm for a diameter from 4 to 6 centimeters and with a useful surface area of 5 to 10 m². In the particular application contemplated here of the static mixer 30 in the in-line heating device 22, a high surface density gives the possibility of obtaining a large useful surface area for heat exchange between the static mixer 30 and the circulating adhesive composition 80. In other words, the deflective surfaces 32 form a heat exchanger with an adapted structure for rapidly setting the application temperature of the adhesive composition 80 present in the sheath 34.

Notably in the case when the static mixer 30 of the in-line heating device 22 would not have a sufficient total exchange surface area, the system 20 may comprise recirculation of the adhesive composition in the in-line heating device 22. This recirculation, not shown, may comprise downstream tapping of the in-line heating device 22 which sends the adhesive composition back to the upstream portion of the in-line heating device 22, for example by means of a circulation pump. Such recirculation gives the possibility of increasing the residence time of the adhesive composition in the in-line heating device 22 without reducing the flow rate of the system 80 and without increasing the dimensions of the static mixer. Moreover, such recirculation facilitates the rise in temperature of the system upon restarting, by allowing circulation of the adhesive composition in the circuit formed by the recirculation and the in-line heating device 22 as long as the in-line heating device 22 has not yet reached the desired temperature.

Finally, because of the circulation of the adhesive composition 80 and of the large exchange surface density, the in-line heating device 22 allows the setting of the temperature of the adhesive composition to the application temperature with a short residence time. The hot application system 20, with the application nozzle 50, the supply line 88 of the nozzle and the in-line heating device 22 may thus apply on the surface 96 crosslinkable adhesive compositions 80 having an application temperature included in the crosslinking range of the adhesive composition 80 by limiting the risks of crosslinking of the adhesive composition 80 in line 88.

The application system 20 is also proposed with the storage reservoir 82 comprising the adhesive composition 80 to be applied and connected to the supply line of the nozzle 50. Further a hot application method for the adhesive composition is further proposed, comprising the provision of such an application system 20. According to this method, the adhesive composition circulates from the storage reservoir to the in-line heating device, for example by means of a circulation pump 46.

The adhesive composition 80 is then heated in-line by means of the heating device 22 because of the supply of electric power to the inductive cable 26. The inductive cable 26 is for example supplied with a high frequency electric current, preferably with a frequency greater than or equal to 1 MHz, such as 15 MHz. Once it is set to the application temperature, the adhesive composition 80 is applied on the surface 96 by the application nozzle 50. According to the example mentioned earlier, the application may be carried out with a viscosity of the fluid of 15 Pa·s ±5 Pa·s. The application temperature may be comprised between 50° C. and 140° C. More particularly, the application temperature may be comprised between 80° C. and 120° C. or further comprised between 100° C. and 110° C.

The proposed application method is particularly advantageous when it belongs to a more general method for producing a crosslinked adhesive support. Such a method for producing a crosslinked adhesive support is particularly proposed. According to this method, the surface 96 is provided so as to be used as a support for applying the adhesive composition 80 according to the hot application method described earlier. Following the application of the adhesive composition 80 on the surface 96, the coated support 98 is subject to a controlled temperature and advantageously to a controlled humidity rate, in order to allow crosslinking of the adhesive composition. The controlled temperature corresponds to a crosslinking temperature of the adhesive composition 80 and is for example comprised between 50° C. and 200° C. More particularly, the crosslinking temperature is comprised between 50° C. and 180° C., preferably between 80° C. and 160° C., more preferably comprised between 100° C. and 150° C. or further comprised between 100° C. and 140° C. As the application system described earlier gives the possibility of applying the hot adhesive composition at an application temperature included in the crosslinking range of the adhesive composition, the proposed method for producing a crosslinked adhesive support is particularly advantageous when the previous ranges of application temperatures intersect with the crosslinking temperature ranges of the adhesive composition 80.

In the proposed system and also for the proposed methods for hot application and production, the adhesive composition 80 to be applied may particularly be an adhesive composition comprising at least one silylated pre-polymer and at least one compatible tackifying resin. This adhesive composition also preferably comprises at least one catalyst. More particularly, the adhesive composition may comprise:
from 20% to 85% by weight, preferably from 30 to 75% by weight of said at least one silylated pre-polymer;
from 15 to 80% by weight, preferably from 25 to 70% by weight of said at least one tackifying resin;
from 0.01 to 3% by weight, preferably from 0.1 to 2% by weight of said at least one catalyst.

The adhesive composition may thus correspond to the adhesive compositions described in document WO 2012/090151 A2, said at least one silylated pre-polymer being for example a polyurethane or a polyether comprising 2 hydrolyzable terminal groups of the alkoxysilane type.

When the adhesive composition 80 is solid or too viscous under standard conditions of temperatures and pressure, i.e. 1 bar at 20° C., heater 44 may also be provided in the storage reservoir 82. Too large viscosity, or even a solid state of the adhesive composition at room temperature may make pumping difficult. The heater 44 in the storage reservoir 82, here barrel-shaped, may then bring the adhesive composition to a pumping temperature, i.e. to a temperature where the viscosity of the adhesive composition is sufficiently low for the pumping with the circulation pump 46. The circulation pump 46 may typically be adapted so as to circulate the adhesive composition 80 having a viscosity of 500 Pa·s, preferably 600 Pa·s. According to a particularly preferred embodiment, the circulation pump 46 may pump the adhesive composition 80 when it has a viscosity of 1,000 Pa·s. In other words, the heater 44 in the storage reservoir then allow the temperature to rise to the pumping temperature. These heater 44 are also particularly useful for melting the adhesive composition when the adhesive composition is solid at a normal temperature and then for bringing the adhesive temperature to the pumping temperature. The pumping temperature of the adhesive composition 80 is for example a temperature from 40° C. to 60° C. In other words, it is the in-line heating device 22 which provides the major portion of the heating energy to the adhesive composition.

According to a preferred embodiment of the proposed system 20, the application nozzle 50 may also be heated. The heating of the nozzle 50 then contributes to setting the application temperature of the adhesive composition 80. Thus, according to this embodiment, the application nozzle 50 belongs to the heating device 22 at the application temperature. The heating of the nozzle 50 gives the possibility of providing heat energy at the end of the line 88 in order to bring the adhesive composition to the final application temperature. As this final application temperature is only reached at the end of the line 88, the residence time at this temperature is short, then limiting the risk of crosslinking of the adhesive composition. However, the heating power of the application nozzle 90 is relatively low, being typically of the order of 200 W. The heating of the adhesive composition via the static mixer 30 heated by induction then provides the largest contribution to the heating to the final application temperature, for example of the order of 10 kW to 20 kW, even if the heated nozzle 90 may finalize the setting of the temperature. According to this embodiment, the static mixer 30 may heat the adhesive composition 80 to a slightly lower temperature, for example by 10° C. or less, than the final application temperature. As the temperature of the adhesive composition 80 in the static mixer 30 is lower than the application temperature, the crosslinking time at this temperature is shorter and the risks of in-line blocking are then further reduced.

According to a preferred embodiment of the in-line heating device 22, the sheath 34 is an insulating material. In this document, by electrically insulating material, is meant a material having a resistivity greater than or equal to 10⁶ Ω·m. The insulating material of the sheath 34 is for example glass or a polymer without any conductive fillers. According to this preferred embodiment, the mixing elements 38 are made in an electrically conducting material so as to allow heating by induction of the static mixer 30. Indeed, as indicated earlier, the inductive cable 26 is able, with a supply of an electric AC current power, of inducing an eddy current in any electric conductor placed in the produced magnetic field. Eddy currents are induced at the surface of the conductor placed in the magnetic field with a penetration depth which may be expressed in the following way:

$$P = \frac{ρ}{π f {μ}_{0} {μ}_{r}} \qquad ( 2 )$$

wherein P is the penetration depth in m;
ρ is the resistivity of the material to be heated in Ω·m;
ƒ is the frequency in Hz of the AC current powering the inductive cable 26;
μ₀ is the vacuum permeability equal to à 4π*10⁻⁷ in H·m⁻¹;
μᵣ is the relative permeability (dimensionless) of the material in which are induced the eddy currents.

By making the sheath 34 in an electrically insulating material and the mixing elements in a conducting material, it is then possible to have the mixing elements as a first conductor in the magnetic field generated by the inductive cable 26 surrounding the sheath 34. Induction of eddy currents is then directly achieved in the mixing elements 38 at the deflective surfaces 32, and not at the sheath 34 placed between the inductive cable and the mixing element 38. By producing induction and a Joule effect at the deflective surfaces 32, it is possible to have more efficient heating of the adhesive composition 80 which comes into direct contact with these deflective surfaces 32 without any intermediate.

According to a less advantageous embodiment, the sheath 34 is in a conducting material, so that the eddy current induction only penetrates the sheath 34 and not the mixing elements 38. The Joule effect then occurs at the sheath 34 and the heat diffuses towards the adhesive composition 80 by conduction via the deflective surfaces 32. In this proposed less advantageous embodiment, heat exchange is less efficient because of the use of an intermediate for conducting the heat.

The preferred embodiment with an insulating sheath 34 of the heating device 22 is proposed for heating any fluid, in addition to the use for heating the adhesive composition 80. The proposed heating device 22 may be used for heating any fluid in fields other than the particular field of application of the hot adhesive composition 80, such as for heating a paint for example. Such an embodiment of the proposed heating device 22 then allows improved induction heating as compared with the use of induction heating where only the outer walls of a mold or of a circulation conduit are heated by induction like in documents: JP 2001 191 364 A, JP 2001 191 380 A, JP 2005/222781 A and US 2011/0116340 A1. In particular in a technical field of heat treatment of food, the aforementioned document JP 2005/222781 A describes the use of induction heating at a circulation conduit, the circulation conduit then diffusing heat by conduction to the food via a mixing element. The use of the proposed heating device 22 with a static mixer provided with an insulating sheath 34 allows heating without any intermediate and is therefore more efficient for the fluid circulating in the static mixer 30.

Of course, the present invention is not limited to the examples and to the described and illustrated embodiments, but many alternatives are possible, accessible to one skilled in the art.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

In the foregoing and in the examples, all temperatures are set forth uncorrected in degrees Celsius and, all parts and percentages are by weight, unless otherwise indicated.

The entire disclosures of all applications, patents and publications, cited herein and of corresponding application No. FR 13/61818, filed Nov. 29, 2013 are incorporated by reference herein.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. A method for hot application of an adhesive composition on a support, the method comprising:
providing an application system for hot application of an adhesive composition on a support, the system comprising:
an application nozzle applying the adhesive composition;
a supply line supplying the nozzle with the adhesive composition to be applied in fluid form;
an in-line heating device heating the adhesive composition to an application temperature, the heating device comprising:
a static mixer including an electrically conducting material, and
an inductive cable surrounding the static mixer;
providing a storage reservoir comprising the adhesive composition to be applied and connected to the supply line of the application nozzle;
circulating the adhesive composition from the storage reservoir to the in-line heating device;
heating the pumped adhesive composition to the application temperature, by the supply of electric power to the inductive cable of the heating device;
hot application of the adhesive composition on a support by means of the application nozzle.

13. The hot application method according to claim 12, wherein the adhesive composition is applied with a viscosity of 15 Pa·s±5 Pa·s.

14. The hot application method according to claim 13, wherein the application system comprising a pump for circulating the adhesive composition in the supply line, the pump being able to circulate an adhesive composition having a viscosity of 1,000 Pa·s.

15. The hot application method according to claim 12, wherein the adhesive composition is applied at a temperature of 50° C. to 140° C.

16. The hot application method according to claim 12, wherein the static mixer of the heating device comprises:
a sheath forming a portion of the supply line for supplying the adhesive composition, the sheath being made in an electrically insulating material, and
a mixing element having deflective surfaces for deflecting the adhesive composition circulating in the sheath, the mixing element being made in an electrically conducting material and positioned in the sheath.

17. The hot application method according to claim 16, wherein the mixing element positioned in the sheath has a heat exchange surface density greater than or equal to 5*10³ m⁻¹.

18. A method for hot application of an adhesive composition on a support, the method comprising:
providing a support;
applying an adhesive composition onto the support by means of a method for hot application of an adhesive composition on a support, the method comprising:
providing an application system for hot application of an adhesive composition on a support, the system comprising:
an application nozzle for applying the adhesive composition;
a supply line for supplying the nozzle with the adhesive composition to be applied in fluid form;
an in-line heating device for heating the adhesive composition to an application temperature, the heating device comprising:
a static mixer including an electrically conducting material, and
an inductive cable surrounding the static mixer;
providing a storage reservoir comprising the adhesive composition to be applied and connected to the supply line of the application nozzle;
circulating the adhesive composition from the storage reservoir to the in-line heating device;
heating the pumped adhesive composition to the application temperature, by the supply of electric power to the inductive cable of the heating device;
hot application of the adhesive composition on a support by means of the application nozzle;
crosslinking the adhesive composition applied at a temperature of 50° C. to 200° C.

19. The method hot application method according to claim 18, wherein the static mixer of the heating device comprises:
a sheath forming a portion of the supply line for supplying the adhesive composition, the sheath being made in an electrically insulating material, and
a mixing element having deflective surfaces for deflecting the adhesive composition circulating in the sheath, the mixing element being made in an electrically conducting material and positioned in the sheath.

20. The method for producing a crosslinked adhesive support according to claim 19, wherein the mixing element positioned in the sheath has a heat exchange surface density greater than or equal to 5*10³ m⁻¹.

21. The hot application method according to claim 16, wherein the sheath is glass or polymer without any conductive fillers.

22. The hot application method according to claim 19, wherein the sheath is glass or polymer without any conductive fillers.
